(19) United States
(12) Patent Application Publication
(10) Pub. No.: US 2021/0317754 A1
(43) Pub. Date: Oct. 14, 2021

(54) HOUSING STRUCTURE FOR ROTARY MACHINE AND METHOD OF MANUFACTURING HOUSING STRUCTURE FOR ROTARY MACHINE

(71) Applicant: MITSUBISHI HEAVY INDUSTRIES, LTD., Tokyo (JP)

(72) Inventors: Toshiaki Kokufuda, Tokyo (JP); Ryutaro Fuzisawa, Tokyo (JP); Toshihiro Takeda, Tokyo (JP); Hao Li, Tokyo (JP); Hikaru Kurosaki, Tokyo (JP)

(21) Appl. No.: 17/203,011

(22) Filed: Mar. 16, 2021

(30) Foreign Application Priority Data
Apr. 9, 2020 (JP) 2020-070255

(51) Int. Cl. F01D 25/14; C01B 32/182; F01D 25/24

(52) U.S. Cl. CPC F01D 25/145; C01B 32/182; F05D 2300/5024; F05D 2300/224; F01D 25/243

(57) ABSTRACT

A housing structure for a rotary machine includes a main body and a heat transfer member. The heat transfer member includes a material having higher thermal conductivity than that of the main body. In addition, the heat transfer member is sandwiched between a first surface and a second surface of the main body while receiving a compressive load from the first surface and the second surface, thereby alleviating temperature distribution that may occur in the main body and reducing thermal deformation.

### CROSS-REFERENCE TO RELATED APPLICATIONS

This application claims the benefit of priority to Japanese Patent Application Number 2020-070255 filed on Apr. 9, 2020. The entire contents of the above-identified application are hereby incorporated by reference.

### TECHNICAL FIELD

The present disclosure relates to a housing structure for a rotary machine and a method of manufacturing the housing structure for the rotary machine.

### RELATED ART

For example, there is known a housing structure for a rotary machine such as a casing accommodating a rotating body including a turbine rotor blade. This type of housing structure accommodates the rotating body with a clearance between the housing structure and the rotating body. Depending on the fluid used, a considerable temperature distribution occurs due to a temperature difference that occurs between the fluid flowing inside and the outside air. Such a temperature distribution causes non-uniform deformation of the housing structure and locally reduces the clearance, which contributes to make contact with the rotating body accommodated inside.

JP 2017-129132 A, for example, is a technology for reducing thermal deformation that occurs in the housing structure. This document discloses a technology in which a graphene sheet having excellent thermal conductivity is provided so as to cover a surface of a casing surrounding a rotating member, thereby alleviating temperature distribution generated in the casing and reducing thermal deformation of the casing.

### SUMMARY

The graphene sheet used in JP 2017-129132 A described above is fixed to the surface of the casing using a fastening member such as a bolt or is fixed with an adhesive. However, when the graphene sheet is fixed using the fastening member, there is a possibility that a considerable gap is generated between the surface of the casing and the graphene sheet to increase thermal resistance therebetween (thermal conductivity decreases), and that the temperature distribution generated in the casing cannot be sufficiently alleviated. In addition, when the graphene sheet is fixed with an adhesive, there is a possibility that the thermal resistance between the graphene sheet and the adhesive is similarly increased (the thermal conductivity is decreased) depending on the component of the adhesive, and that the temperature distribution generated in the casing cannot be sufficiently alleviated.

At least one embodiment of the present disclosure has been made in view of the above-described circumstances, and an object thereof is to provide a housing structure for a rotary machine capable of favorably reducing thermal deformation due to temperature distribution, and to provide a method of manufacturing the housing structure for the rotary machine.

In order to solve the above problems, a housing structure for a rotary machine according to at least one embodiment of the present disclosure is a housing structure for a rotary machine, the housing structure enclosing a rotating body at least partially and including: a main body including a first surface and a second surface facing each other; and a heat transfer member including a material having higher thermal conductivity than that of the main body, the heat transfer member being sandwiched between the first surface and the second surface while receiving a compressive load from the first surface and the second surface.

In order to solve the above problems, a method of manufacturing a housing structure for a rotary machine according to at least one embodiment of the present disclosure is a method of manufacturing a housing structure for a rotary machine, the housing structure enclosing a rotating body at least partially, the method including: processing a main body such that a first surface and a second surface are formed to face each other; and inserting a heat transfer member into a gap formed between the first surface and the second surface, the heat transfer member having a thickness set such that the gap becomes zero during operation of the rotary machine.

According to at least one embodiment of the present disclosure, it is possible to provide a housing structure for a rotary machine capable of favorably reducing thermal deformation due to temperature distribution, and to provide a method of manufacturing the housing structure for the rotary machine.

### BRIEF DESCRIPTION OF DRAWINGS

The disclosure will be described with reference to the accompanying drawings, wherein like numbers reference like elements.

FIG. 1 is a schematic diagram illustrating a rotary machine according to at least one embodiment of the present disclosure.

FIG. 2 is a perspective view illustrating a housing structure according to a first embodiment.

FIG. 3 is a cross-sectional view taken along A of FIG. 2.

FIG. 4 is a flowchart illustrating, step by step, a method of manufacturing the housing structure according to the first embodiment.

FIG. 5 is a manufacturing process diagram corresponding to FIG. 4.

FIG. 6 is a cross-sectional view illustrating a gap including a crushing space.

FIG. 7 is a perspective view illustrating a housing structure according to a second embodiment.

FIG. 8 is a cross-sectional view taken along B of FIG. 7.

FIG. 9 is a plan view illustrating the housing structure of FIG. 7 from above.

FIG. 10 is a modified example of FIG. 8.

FIG. 11 is a flowchart illustrating, step by step, a method of manufacturing the housing structure according to the second embodiment.

FIG. 12 is a manufacturing process diagram corresponding to FIG. 11.

FIG. 13A is a cross-sectional view illustrating an example of forming gaps in a basic structure.

FIG. 13B is a cross-sectional view illustrating an example of forming the gaps in the basic structure.

FIG. 13C is a cross-sectional view illustrating an example of forming the gaps in the basic structure.

FIG. 13D is a cross-sectional view illustrating an example of forming the gaps in the basic structure.

FIG. 14 is another modified example of FIG. 8.

FIG. 15 is a cross-sectional view illustrating a housing structure according to a third embodiment from an axial direction.

FIG. 16 is a perspective view of a modified example of the housing structure according to the third embodiment.

FIG. 17 is a perspective view of a housing structure according to a fourth embodiment.

FIG. 18 is a perspective view of a housing structure according to a fifth embodiment.

FIG. 19 is a cross-sectional view perpendicular to the axial direction in the vicinity of a communication hole in FIG. 18.

FIG. 20 is a modified example of FIG. 19.

### DESCRIPTION OF EMBODIMENTS

Hereinafter, some embodiments of the present invention will be described with reference to the accompanying drawings. However, dimensions, materials, shapes, relative arrangements, or the like of components described in the embodiments or illustrated in the drawings are not intended to limit the scope of the present invention thereto, and are merely illustrative examples.

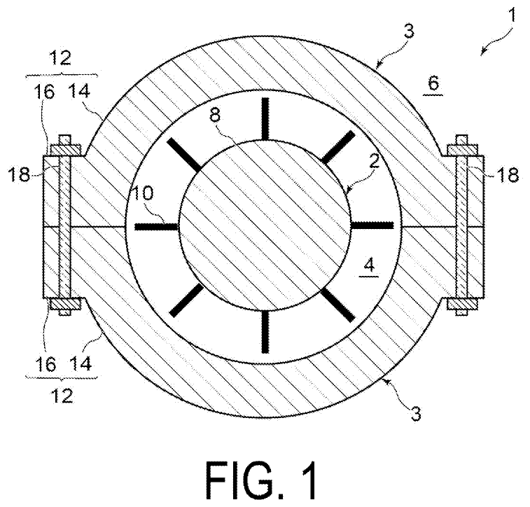

FIG. 1 is a schematic diagram illustrating a rotary machine 1 according to at least one embodiment of the present disclosure. The rotary machine 1 includes a rotating body 2 capable of rotating and housing structures 3 capable of accommodating the rotating body 2 inside. In the present embodiment, a turbine machine will be described as an example of the rotary machine 1. The rotating body 2 is a turbine rotor including a rotor shaft 8 and a plurality of turbine rotor blades 10 provided on the rotor shaft 8 along the circumferential direction, and is accommodated in the housing structures 3 serving as a turbine casing.

The housing structures 3 are configured to separate an inside space 4 in which the rotating body 2 is accommodated from an outside space 6 located radially outward of the inside space 4. As a working gas used for rotationally driving the rotating body 2, a high-temperature gas generated by a combustor (not illustrated) is introduced into the inside space 4. The turbine rotor blades 10 receive the working gas, so that the rotating body 2 is rotationally driven. The outside space 6 is, for example, outside air. During operation of the rotary machine 1, the inside space 4 into which high-temperature working gas is introduced has a higher temperature than the outside space 6. Therefore, a predetermined temperature distribution may occur in the housing structures 3 according to the temperature difference between the inside space 4 and the outside space 6.

Each housing structure 3 has a semi-cylindrical shape, and the two housing structures 3 are combined with each other to surround the entire circumference of the rotating body 2. In FIG. 1, a cross-section perpendicular to the axial direction of the rotor shaft 8 is illustrated, and the housing structure 3 constituting the upper half and the housing structure 3 constituting the lower half are combined with each other, whereby the inside space 4 and the outside space 6 are separated from each other.

A main body 12 of each of the two housing structures 3 includes a curved portion 14 extending along the circumferential direction and flange portions 16 provided at both ends of the curved portion 14 in a cross-section perpendicular to the axial direction. The two housing structures 3 are connected to each other by fastening the flange portions 16 to each other with fastening members 18 such as bolts and nuts in a state where the flange portions 16 face each other (the flange portions 16 may be connected to each other by welding instead of or in addition to the fastening members 18).

In the following description, one of the two housing structures 3 will be mainly described, but unless otherwise specified, the configuration of the other is the same.

### First Embodiment

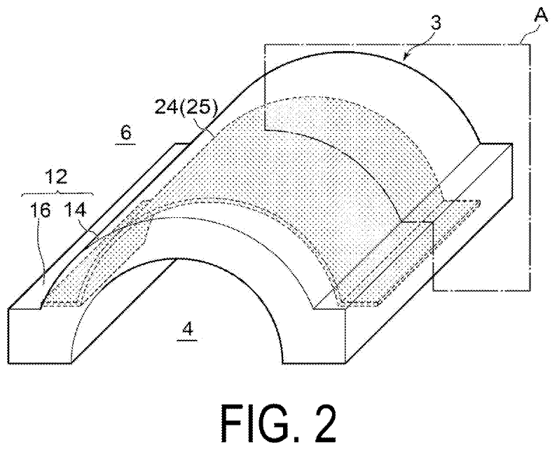

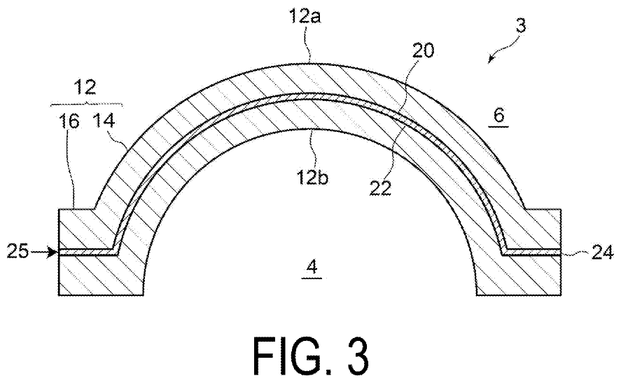

FIG. 2 is a perspective view illustrating the housing structure 3 according to the first embodiment, and FIG. 3 is a cross-sectional view taken along A of FIG. 2. As illustrated in FIG. 3, the main body 12 of the housing structure 3 includes an outer diameter side segment 12a and an inner diameter side segment 12b that are divided from each other in the radial direction (thickness direction). The outer diameter side segment 12a and the inner diameter side segment 12b are divided from the curved portion 14 to the flange portions 16 such that the outer diameter side segment 12a and the inner diameter side segment 12b have substantially equal thicknesses.

The outer diameter side segment 12a has a first surface 20 on the inner circumferential side, and the inner diameter side segment 12b has a second surface 22 on the outer circumferential side. A heat transfer member 24 is sandwiched in a gap 25 defined by the first surface 20 and the second surface 22. The heat transfer member 24 contains a material having higher thermal conductivity than that of the main body 12. In the present embodiment, as the heat transfer member 24, a heat transfer sheet is used, which is formed by laminating graphene sheets having high thermal conductivity in the in-plane direction.

Other preferable examples of the material that can be used for the heat transfer member 24 include a material that is easily molded and has excellent thermal conductivity, such as a composite material of a metal (one or more of copper, aluminum, iron, nickel, or the like) and a crystalline carbon material (one or more of graphite, fullerene, carbon nanotube, diamond, or the like).

The heat transfer member 24 is sandwiched between the first surface 20 and the second surface 22 while receiving a compressive load from the first surface 20 and the second surface 22. The gap 25 for sandwiching the heat transfer member 24 between the outer diameter side segment 12a and the inner diameter side segment 12b is set to be narrower than the thickness of the heat transfer member 24 before being sandwiched in the gap 25 (e.g., the heat transfer member 24 that is in the atmosphere and thus does not receive a compressive load). Thus, by compressively sandwiching the heat transfer member 24 in the gap 25, the heat transfer member 24 is arranged in the gap 25 while receiving the compressive load from the first surface 20 and the second surface 22. Since the heat transfer member 24 is arranged in the gap 25 while receiving the compressive load in this manner, the heat transfer member 24 comes into favorable contact with the main body 12, and the thermal resistance between the heat transfer member 24 and the main body 12 is reduced. As a result, the temperature distribution that may occur in the housing structure 3 can be alleviated by the heat transfer member 24, and thermal deformation can be effectively suppressed.

The heat transfer member 24 may include a material having a Young's modulus smaller than that of the main body 12. In this case, when the heat transfer member 24 is sandwiched between the outer diameter side segment 12a and the inner diameter side segment 12b and subjected to a compressive load, the heat transfer member 24 is compressively deformed earlier than the outer diameter side segment 12a and the inner diameter side segment 12b. This allows the compressive load to effectively act on the heat transfer member 24 sandwiched in the gap 25.

The heat transfer member 24 may include a material having a linear expansion coefficient larger than that of the main body 12. As a result, when the ambient temperature rises during operation of the rotary machine 1, the heat transfer member 24 expands to a greater extent than the main body 12, and therefore a compressive load can be effectively applied to the heat transfer member 24 sandwiched in the gap 25.

Such a heat transfer member 24 directly contacts the first surface 20 and the second surface 22. That is, the heat transfer member 24 is disposed adjacent to the main body 12 without a layer such as an adhesive interposed. Thus, the thermal resistance between the heat transfer member 24 and the main body 12 can be reduced, and the temperature distribution that may occur in the housing structure 3 can be effectively alleviated.

In addition, the first surface 20 and the second surface 22 of the main body 12 with which the heat transfer member 24 contacts may include various configurations for improving thermal conductivity. As such a configuration, for example, the roughness of the first surface 20 and the second surface 22 may be appropriately adjusted. For example, by adjusting the roughness of the first surface 20 and the second surface 22 to be large, the local surface pressure when the compressive load is applied is increased, and the metal and the graphene are brought into contact with each other strongly and reliably, whereby the thermal conductivity may be improved. Additionally, by adjusting the roughness of the first surface 20 and the second surface 22 to be small, the contact thermal resistance is reduced, whereby the thermal conductivity may be increased. Such adjustment of the roughness may be executed by performing a predetermined surface treatment on the first surface 20 and the second surface 22.

In the first embodiment, the heat transfer member 24 extends along the circumferential direction. This can favorably alleviate temperature distribution along the circumferential direction that may occur in the main body 12 due to the temperature difference between the inside space 4 and the outside space 6. In particular, in the main body 12 including the flange portions 16, temperature distribution is likely to occur in the vicinity of each flange portion 16 due to a change in heat capacity compared to the curved portion 14. However, by providing the heat transfer member 24 from the curved portion 14 to the flange portions 16 in the main body 12, it is possible to alleviate the temperature distribution along the circumferential direction over the entire main body 12 including the flange portions 16.

The heat transfer member 24 may be formed only in the curved portion 14 without being formed in the flange portions 16. In this case, although the above-described effect relating to the flange portions 16 is reduced, the heat transfer member 24 is not interposed between the flange portions 16 when the flange portions 16 are fastened to each other by the fastening members 18, and thus it is easy to manage the fastening force.

Since the heat transfer member 24 also extends along the axial direction, the temperature distribution along the axial direction can also be favorably alleviated. The heat transfer member 24 may have any length along the axial direction. However, for example, in the case of a specification that requires a small temperature distribution along the axial direction, the temperature distribution along the axial direction can be favorably alleviated by increasing the length of the heat transfer member 24 along the axial direction. On the other hand, in the case of a specification that does not require a small temperature distribution along the axial direction, the length of the heat transfer member 24 along the axial direction may be reduced.

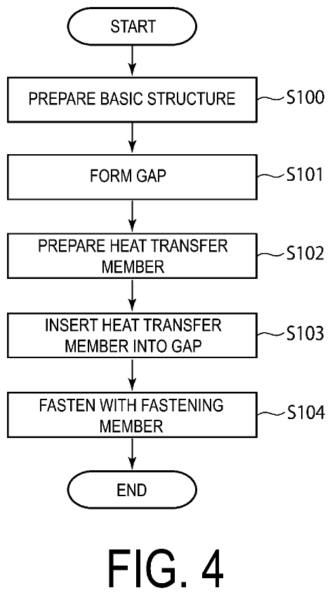

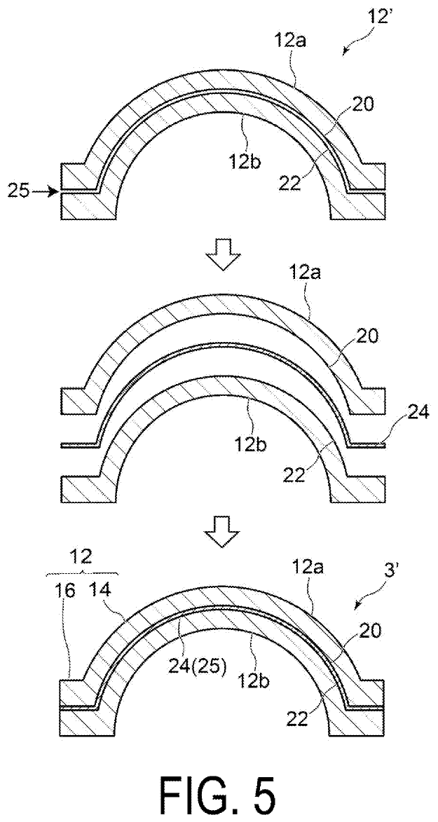

Next, a method of manufacturing the housing structure 3 according to the first embodiment having the above-described configuration will be described. FIG. 4 is a flowchart illustrating, step by step, the method of manufacturing the housing structure 3 according to the first embodiment, and FIG. 5 is a manufacturing process diagram corresponding to FIG. 4.

First, a basic structure 12′, which serves as a base constituting the main body 12 of the housing structure 3, is prepared (step S100). The basic structure 12′ is a structure corresponding to the main body 12 before being divided into the outer diameter side segment 12a and the inner diameter side segment 12b, and each of the outer diameter side segment 12a and the inner diameter side segment 12b is configured to have sufficient strength when divided.

Subsequently, the gap 25 for sandwiching the heat transfer member 24 is formed in the basic structure 12′ prepared in step S100 (step S101). The gap 25 in step S101 may be formed by, for example, dividing the basic structure 12′ in the radial direction into the outer diameter side segment 12a having the first surface 20 on the inner circumferential side and the inner diameter side segment 12b having the second surface 22 on the outer circumferential side.

The gap 25 in step S101 may be formed by, for example, designing the outer diameter side segment 12a and the inner diameter side segment 12b such that the outer diameter side segment 12a and the inner diameter side segment 12b are manufactured as separate members in advance and, when combined, have the gap 25 therebetween.

Subsequently, the heat transfer member 24 is prepared (step S102) and inserted into the gap 25 (step S103). A thickness Lt (radial length) of the heat transfer member 24 prepared in step S102 is set such that the heat transfer member 24 is deformed to expand during operation and thus comes into contact with the first surface 20 and the second surface 22. For example, when the size of the gap 25 is L, the linear expansion coefficient of the main body 12 is αₘₑₜₐₗ, and the linear expansion coefficient of the heat transfer member 24 is α, the thickness Lt is obtained by the following expression:

Lt≥L×αₘₑₜₐₗ/α

Then, in a state where the heat transfer member 24 is inserted in the gap 25, the outer diameter side segment 12a and the inner diameter side segment 12b are fastened by the fastening member 18 (step S104). As a result, a compressive load is applied from the first surface 20 and the second surface 22 to the heat transfer member 24 inserted into the gap 25.

Note that the size of the gap 25 is set such that the heat transfer member 24 having the thickness Lt designed by the above expression comes into close contact with the first surface 20 and the second surface 22 when the heat transfer member 24 is inserted and deformed to expand during operation. FIG. 5 illustrates a case in which the heat transfer member 24 is provided up to the flange portions 16. However, when the heat transfer member 24 is provided only in the curved portion 14 and is not provided in the flange portions 16, the first surface 20 and the second surface 22 of the flange portion 16 may be designed to come into contact with each other during operation.

In the housing structure 3 manufactured in this manner, the heat transfer member 24 is sandwiched between the first surface 20 and the second surface 22 while receiving the compressive load. Thus, the heat transfer member 24 is brought into favorable contact with the main body 12, and the thermal resistance between the heat transfer member 24 and the main body 12 is reduced. As a result, the temperature distribution that may occur in the housing structure 3 is alleviated by the heat transfer member 24, and thermal deformation is effectively suppressed.

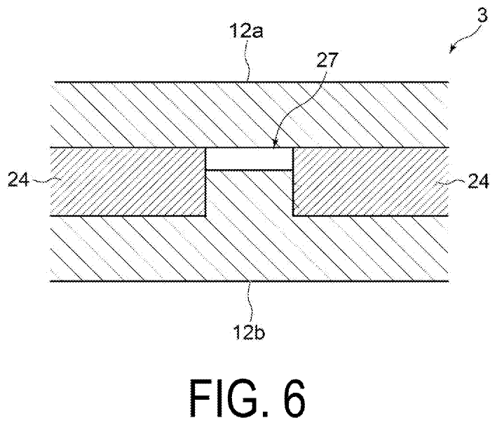

The size of the gap 25 formed in step S101 is set based on the thickness of the heat transfer member 24 inserted into the gap 25 and the magnitude of the compressive load to be received by the heat transfer member 24. The size of the gap 25 may include the size of a crushing space 27 that disappears when the heat transfer member 24 is compressed. FIG. 6 is a cross-sectional view illustrating the gap 25 including the crushing space 27. In FIG. 6, the crushing space 27 having a predetermined depth is provided in a region where the heat transfer member 24 is not disposed when the heat transfer member 24 is inserted between the outer diameter side segment 12a and the inner diameter side segment 12b. The crushing space 27 is designed to disappear by being compressed together when the heat transfer member 24 is compressed by fastening the outer diameter side segment 12a and the inner diameter side segment 12b in step S104. This makes it possible to more easily manage the compressive load received by the heat transfer member 24 in the gap 25.

The crushing space 27 may have any shape when viewed from the radial direction, and may be provided in a slit shape or a lattice shape, for example.

### Second Embodiment

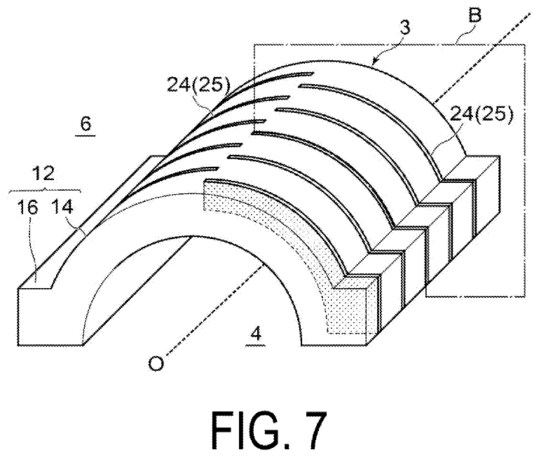

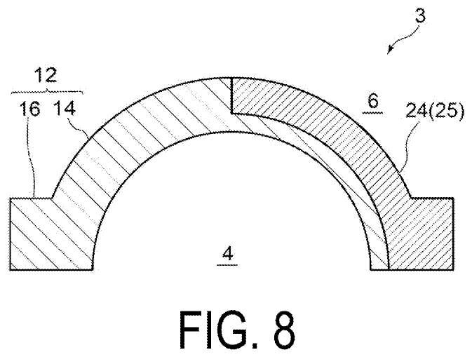

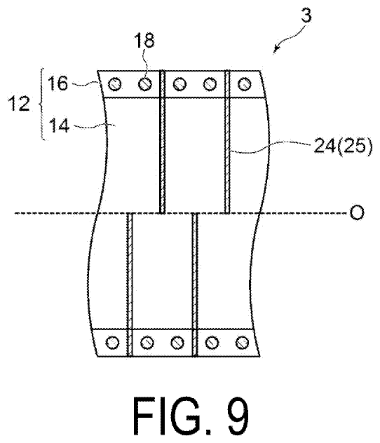

FIG. 7 is a perspective view illustrating a housing structure 3 according to a second embodiment, FIG. 8 is a cross-sectional view taken along B of FIG. 7, and FIG. 9 is a plan view illustrating the housing structure 3 of FIG. 7 from above.

In the housing structure 3 according to the second embodiment, a main body 12 is not divided into an outer diameter side segment 12a and an inner diameter side segment 12b, and a heat transfer member 24 is sandwiched in a gap 25 extending in a slit shape along the radial direction and the circumferential direction. The gap 25 is formed as a gap defined by a first surface 20 and a second surface 22 facing each other inside the gap 25. The heat transfer member 24 extending in the radial direction and the circumferential direction, similar to the gap 25, is sandwiched in the gap 25 while receiving a compressive load from the first surface 20 and the second surface 22. This can favorably alleviate the temperature distribution along the radial direction and the circumferential direction that may occur in the main body 12 due to the temperature difference between the inside space 4 and the outside space 6.

As illustrated in FIGS. 7 and 9, a plurality of the heat transfer members 24 each sandwiched in a corresponding one of the gaps 25 may be provided along the axial direction. In the present example, the plurality of heat transfer members 24 are alternately arranged along the axial direction on the left and right sides with respect to the central axis O of the main body 12. As a result, the temperature distribution that may occur along the axial direction can also be favorably alleviated.

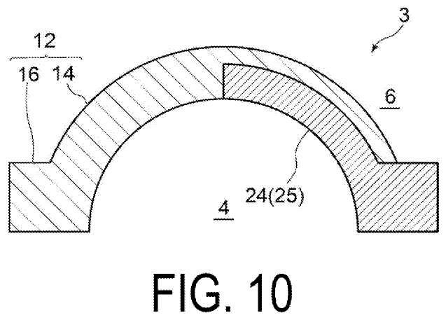

FIG. 10 illustrates a modified example of FIG. 8. In FIG. 8 described above, the gaps 25 and the heat transfer members 24 are formed in the main body 12 on the outer diameter side, but may be formed on the inner diameter side as in a modified example illustrated in FIG. 10.

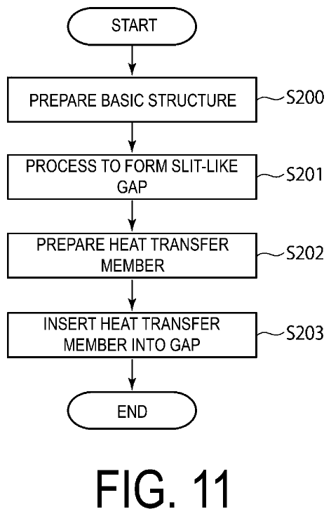

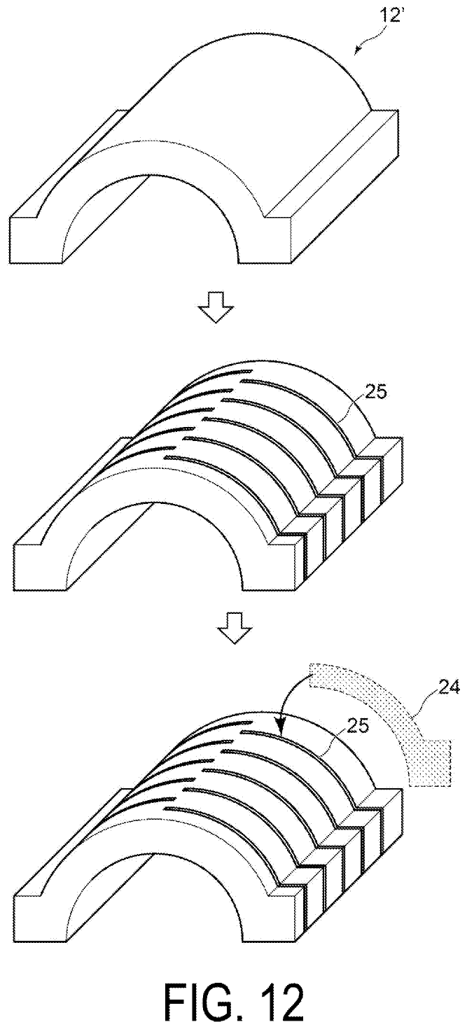

Here, a method of manufacturing the housing structure 3 according to the second embodiment having the above-described configuration will be described. FIG. 11 is a flowchart illustrating, step by step, the method of manufacturing the housing structure 3 according to the second embodiment, and FIG. 12 is a manufacturing process diagram corresponding to FIG. 11.

First, as in step S100 of the first embodiment, the basic structure 12′ serving as a base of the housing structure 3 is prepared (step S200). Then, by processing the basic structure 12′ prepared in step S200, the slit-like gaps 25 for sandwiching the heat transfer members 24 are formed (step S201). In the present embodiment, the plurality of gaps 25 extending along the radial direction and the circumferential direction are formed in the main body 12 on the outer diameter side along the axial direction.

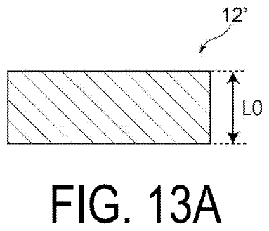

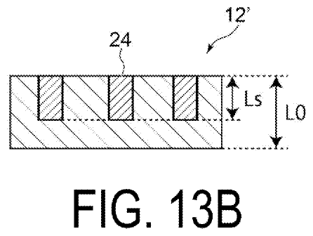

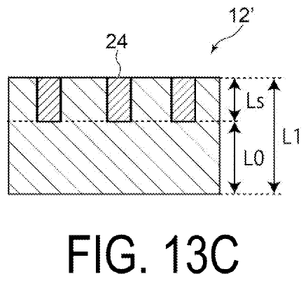

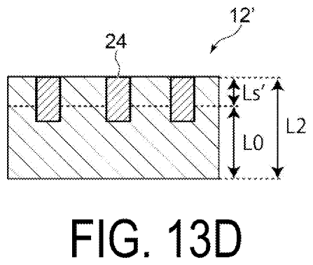

Here, the gaps 25 in step S201 are formed so that the basic structure 12′ has sufficient strength. Here, a case where an out-of-plane load applied to the basic structure 12′ is known in advance will be specifically described as an example. FIGS. 13A to 13D are cross-sectional views illustrating an example of forming the gaps 25 in the basic structure 12′. In FIGS. 13A to 13D, the shape of the basic structure 12′ is simplified for easy understanding.

FIG. 13A illustrates an initial state of the basic structure 12′ in which the gaps 25 are not formed, and the basic structure 12′ has a reference thickness L0 corresponding to the strength required in the specification (the reference thickness L0 is set according to, for example, an out-of-plane load applied to the basic structure 12′). FIG. 13B illustrates a state in which the slit-like gaps 25 having a predetermined depth Ls (radial length) are formed in the basic structure 12′ illustrated in FIG. 13A. In this case, the remaining thickness of the portion of the basic structure 12′ where each gap 25 is formed is (L0−Ls), which reduces the strength of the basic structure 12′ compared to the initial state illustrated in FIG. 13A and thus is not preferable.

FIG. 13C illustrates a case where the basic structure 12′ illustrated in FIG. 13A is thickened by a thickness corresponding to the depth Ls of the slit-like gaps 25 on the outer diameter side where the gaps 25 are formed. In this case, the thickness L0 of the original basic structure 12′ illustrated in FIG. 13A is increased, on the outer diameter side, by the thickness corresponding to the depth Ls of the gaps 25 to obtain the thickness L1 of the basic structure 12′, and thus the basic structure 12′ can have sufficient strength. However, his is disadvantageous in that the size and weight become excessive.

FIG. 13D illustrates a case in which the basic structure 12′ is designed such that depth L2 is intermediate between those of FIGS. 13B and 13C. Compared to the thickness L0, the thickness L2 of the basic structure 12′ in FIG. 13D has an additional thickness Ls′ (0<Ls′<Ls) on the outer diameter side where the gaps 25 are formed. This makes it possible to reduce the size and weight of the basic structure 12′ while allowing the basic structure 12′ to have appropriate strength when the gaps 25 are formed.

Subsequently, the heat transfer members 24 are prepared for the main body 12 in which the slit-like gaps 25 are formed in step S201 (step S202), and are inserted into the gaps 25 (step S203). The thickness Lt (radial length) of each heat transfer member 24 prepared in step S202 is set such that the heat transfer member 24 is deformed to expand during operation and thus comes into contact with the first surface 20 and the second surface 22. For example, when the size of the gap 25 is L, the linear expansion coefficient of the main body 12 is αₘₑₜₐₗ, and the linear expansion coefficient of the heat transfer member 24 is α, the thickness Lt is obtained by the following expression:

Lt≥L×αₘₑₜₐₗ/α

Each heat transfer member 24 is inserted into a corresponding one of the gaps 25 in step S203 by heating the main body 12 or cooling the heat transfer member 24. In the former case, for example, the heat transfer member 24 is inserted while the gap 25 is temporarily expanded to the thickness of the heat transfer member 24 or more by heating the main body 12, and then the whole is cooled (so-called shrink fitting is performed). In the latter case, for example, the heat transfer member 24 is cooled and temporarily contracted to less than the thickness of the gap 25 and inserted into the gap 25, and then the whole is returned to normal temperature (so-called cold fitting is performed). Thus, the heat transfer member 24 having a thickness larger than that of the gap 25 can be accurately inserted into the gap 25, and the compressive load can be effectively applied to the heat transfer member 24 inserted into the gap 25 from the first surface 20 and the second surface 22 constituting the gap 25.

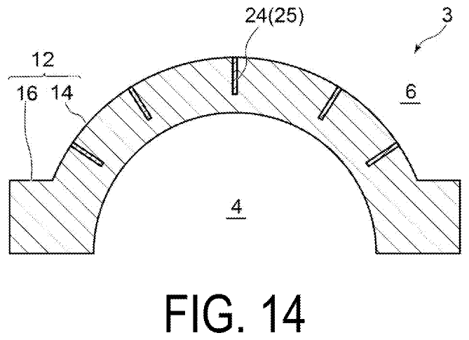

FIG. 14 illustrates another modified example of FIG. 8. In the present modified example, since the slit-like gap 25 extends along the radial direction and the axial direction, the heat transfer member 24 inserted into the gap 25 also extends along the radial direction and the axial direction. This can favorably alleviate the temperature distribution along the radial direction and the axial direction that may occur in the main body 12 due to the temperature difference between the inside space 4 and the outside space 6. In addition, in FIG. 14, by further providing a plurality of the heat transfer members 24 and gaps 25 having such a configuration along the circumferential direction, the temperature distribution along the circumferential direction can also be alleviated.

### Third Embodiment

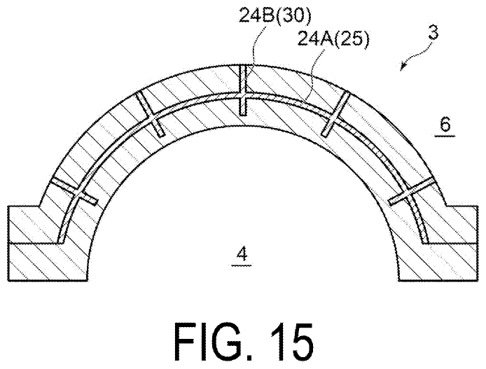

FIG. 15 is a cross-sectional view illustrating a housing structure 3 according to a third embodiment from the axial direction. A heat transfer member 24 included in the housing structure 3 according to the third embodiment includes a first heat transfer member 24A extending along the circumferential direction and the axial direction as in the first embodiment described above, and a second heat transfer member 24B extending along the radial direction and the axial direction as in the second embodiment described above. This can alleviate the temperature distribution along the circumferential direction, the radial direction, and the axial direction, which may be generated in the main body 12 due to the temperature difference between the inside space 4 and the outside space 6.

When the first heat transfer member 24A and the second heat transfer member 24B each include a heat transfer sheet formed by laminating graphene sheets, the graphene sheets have an anisotropic property in which the thermal conductivity along the in-plane direction increases. Therefore, by using, as the first heat transfer member 24A, the heat transfer sheet in which the graphene sheets, whose in-plane directions are along the circumferential direction and the axial direction, are laminated in the radial direction, it is possible to favorably alleviate the temperature distribution along the circumferential direction and the axial direction. Moreover, by using, as the second heat transfer member 24B, the heat transfer sheet in which the graphene sheets, whose in-plane directions are along the radial direction and the axial direction, are laminated in the circumferential direction, it is possible to favorably alleviate the temperature distribution along the radial direction and the axial direction. In this way, when a laminated material having anisotropy in thermal conductivity is used, the heat transfer member 24 may be configured such that the lamination direction differs according to the extending direction.

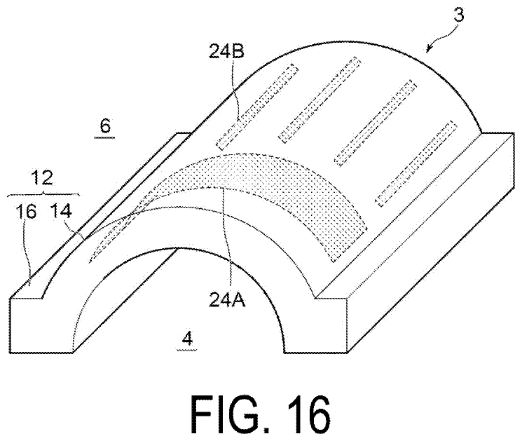

The first heat transfer member 24A and the second heat transfer member 24B may be configured as separate members or may be configured integrally with each other. FIG. 16 is a perspective view of a modified example of the housing structure 3 according to the third embodiment. In the present modified example, the first heat transfer member 24A and the second heat transfer member 24B are configured as separate members from each other, and are formed such that the axial positions of the first heat transfer member 24A and the second heat transfer member 24B alternate with each other. Such a configuration can also favorably alleviate temperature distribution along the circumferential direction, the radial direction, and the axial direction, which may occur in the main body 12 due to the temperature difference between the inside space 4 and the outside space 6.

### Fourth Embodiment

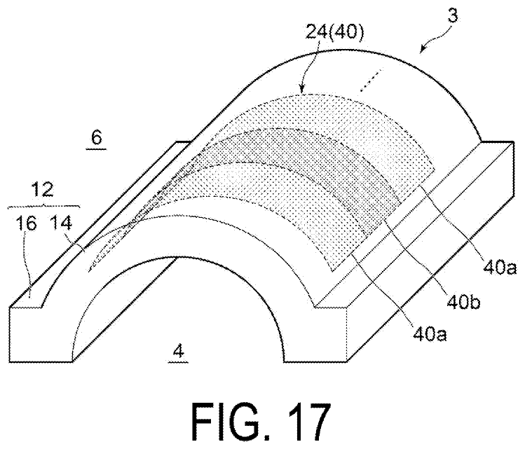

FIG. 17 is a perspective view of a housing structure 3 according to a fourth embodiment. In the fourth embodiment, a heat transfer member 24 includes, along the axial direction, a plurality of heat transfer sheets 40 having different heat transfer directions. Specifically, the heat transfer member 24 is configured by repeatedly disposing a first heat transfer sheet 40a and a second heat transfer sheet 40b adjacent to the first heat transfer sheet 40a along the axial direction. The first heat transfer sheet 40a is constituted such that graphene sheets, whose in-plane directions are along the circumferential direction and the axial direction, are radially laminated. Thus, the first heat transfer sheet 40a has excellent heat transfer characteristics along the circumferential direction and the axial direction. The second heat transfer sheet 40b is constituted such that graphene sheets, whose in-plane directions are along the circumferential direction and the radial direction, are axially laminated. Thus, the second heat transfer sheet 40b has excellent heat transfer characteristics along the circumferential direction and the radial direction.

The heat transfer member 24 is configured by combining the plurality of heat transfer sheets 40 having different heat transfer directions in this manner, and thus it is possible to create the housing structure 3 capable of alleviating temperature distribution in various directions and effectively reduce thermal deformation.

### Fifth Embodiment

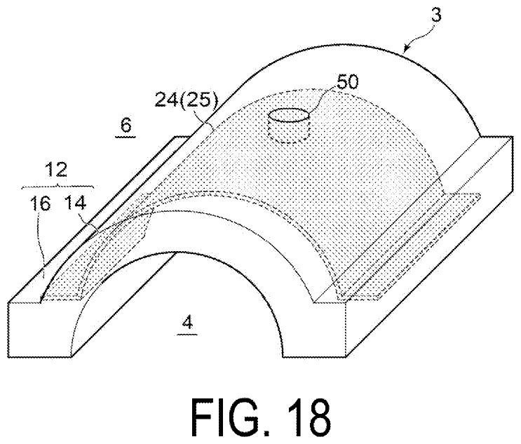

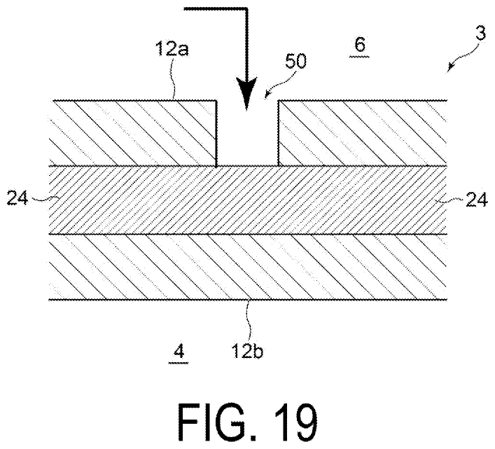

FIG. 18 is a perspective view of a housing structure 3 according to a fifth embodiment, and FIG. 19 is a cross-sectional view perpendicular to the axial direction in the vicinity of a communication hole 50 of FIG. 18. In the housing structure 3 according to the fifth embodiment, the communication hole 50 is formed so as to couple a heat transfer member 24, disposed inside a main body 12 while receiving a compressive load, with an outside space 6. Thus, the outside air in the outside space 6 is introduced into the heat transfer member 24 through the communication hole 50, whereby heat exchange is promoted and the temperature of the heat transfer member 24 is stabilized. Thus, the above-described alleviation of the temperature distribution by the heat transfer member 24 can be more effectively performed.

A plurality of such communication holes 50 may be formed in the main body 12. In this case, the communication holes 50 may be arranged according to the temperature distribution that may occur in the main body 12 according to the temperature difference between an inside space 4 and the outside space 6.

Although FIGS. 18 and 19 illustrate the case where the communication hole 50 is formed on the outer diameter side of the main body 12, the communication hole 50 may be formed on the inner diameter side of the main body 12. In this case, by introducing the high-temperature working gas from the inside space 4 through the communication hole 50, the temperature of the heat transfer member 24 is thus stabilized, and the above-described alleviation of the temperature distribution by the heat transfer member 24 can be more effectively performed.

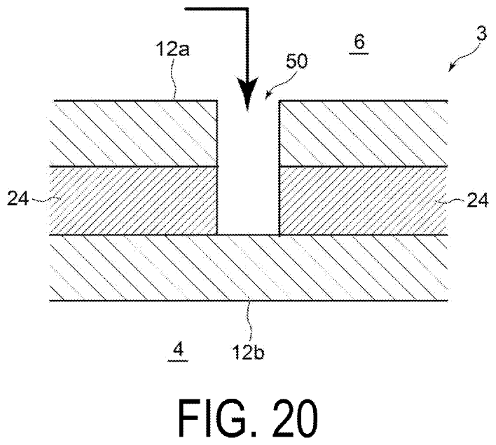

FIG. 20 illustrates a modified example of FIG. 19. In the present modified example, the communication hole 50 is also formed in the heat transfer member 24 in addition to the main body 12. Thus, the temperature of the heat transfer member 24 can be more effectively stabilized.

As described above, according to each of the embodiments described above, the heat transfer member 24 is sandwiched between the first surface 20 and the second surface 22 of the main body 12 while receiving the compressive load. As a result, the heat transfer member 24 is brought into favorable contact with the main body 12, and the thermal resistance between the heat transfer member 24 and the main body 12 is reduced. As a result, the temperature distribution of the housing structure 3 can be alleviated by the heat transfer member 24, and the thermal deformation can be effectively suppressed.

In addition, it is possible to replace the components in the above-described embodiments with well-known components as appropriate without departing from the spirit of the present disclosure, and the above-described embodiments may be combined as appropriate.

The content described in each of the above embodiments are understood as follows, for example.

(1) A housing structure for a rotary machine according to one aspect is a housing structure (e.g., the housing structure 3 of the above embodiment) for a rotary machine (e.g., the rotary machine 1 of the above embodiment), the housing structure enclosing a rotating body (e.g., the rotating body 2 of the above embodiment) at least partially and including: a main body (e.g., the main body 12 of the above embodiment) including a first surface (e.g., the first surface 20 of the above embodiment) and a second surface (e.g., the second surface 22 of the above embodiment) facing each other; and a heat transfer member (e.g., the heat transfer member 24 of the above embodiment) including a material having higher thermal conductivity than that of the main body, the heat transfer member being sandwiched between the first surface and the second surface while receiving a compressive load from the first surface and the second surface.

According to the above aspect (1), the heat transfer member is sandwiched between the first surface and the second surface of the main body while receiving the compressive load. Accordingly, the heat transfer member is brought into favorable contact with the main body, and thermal resistance between the heat transfer member and the main body is reduced. As a result, the temperature distribution of the housing structure can be alleviated by the heat transfer member, and thermal deformation can be effectively suppressed.

(2) In another aspect, in the above aspect (1), the heat transfer member extends along a circumferential direction of the rotary machine.

According to the aspect (2), by providing the heat transfer member along the circumferential direction of the rotary machine, it is possible to favorably alleviate temperature distribution that may occur along the circumferential direction of the housing structure.

(3) In another aspect, in the above aspect (2), the first surface and the second surface are inner surfaces of the main body divided in a radial direction of the rotary machine.

According to the aspect (3), by sandwiching the heat transfer member along the circumferential direction between the inner surfaces of the main body divided in the radial direction, it is possible to favorably alleviate temperature distribution that may occur along the circumferential direction of the housing structure.

(4) In another aspect, in the above aspect (2) or (3), the main body includes: a curved portion (e.g., the curved portion 14 of the above embodiments) configured to partially surround the rotating body; and a flange portion (e.g., the flange portion 16 of the above embodiments) provided at an end of the curved portion, and the heat transfer member is provided from the curved portion to the flange portion.

According to the above aspect (4), when the housing structure includes the flange portion, the heat transfer member is also provided in the flange portion. In the vicinity of the flange portion, temperature distribution is likely to occur because the heat capacity is different from that of the curved portion. However, by providing the heat transfer member in this manner, it is possible to effectively alleviate the temperature distribution even in the housing structure including the flange portion.

(5) In another aspect, in any one of the above aspects (1) to (4), the heat transfer member extends along a radial direction of the rotary machine.

According to the above aspect (5), by providing the heat transfer member along the radial direction of the rotary machine, it is possible to favorably alleviate temperature distribution that may occur along the radial direction of the housing structure.

(6) In another aspect, in the above aspect (5), the first surface and the second surface are inner surfaces of a slit-like gap (e.g., the gap 25 of the above embodiments) formed in the main body.

According to the above aspect (6), the heat transfer member is sandwiched in the slit-like gap formed in the main body, and thus it is possible to favorably alleviate temperature distribution that may occur along the radial direction of the housing structure while reducing a decrease in the strength of the housing structure.

(7) In another aspect, in any one of the above aspects (1) to (6), the heat transfer member extends along an axial direction of the rotary machine, or a plurality of the heat transfer members are arranged along the axial direction of the rotary machine.

According to the above aspect (7), it is possible to effectively alleviate temperature distribution that may occur along the axial direction of the housing structure.

(8) In another aspect, in any one of the above aspects (1) to (7), the main body includes a communication hole (e.g., the communication hole 50 of the above embodiments) configured to communicate the heat transfer member with an outside space (e.g., the outside space 6 of the above embodiments) or an inside space (e.g., the inside space 4 of the above embodiments) of the main body.

According to the above aspect (8), heat transfer to the heat transfer member is promoted by providing the communication hole in the main body, and thus it is possible to effectively alleviate temperature distribution that may occur in the housing structure.

(9) In another aspect, in any one of the above aspects (1) to (8), the heat transfer member is in direct contact with the first surface and the second surface.

According to the above aspect (9), since the heat transfer member is in direct contact with the first surface and the second surface of the main body, it is possible to reduce the thermal resistance and effectively alleviate the temperature distribution of the housing structure.

(10) In another aspect, in any one of the above aspects (1) to (9), the first surface and the second surface are adjusted to have roughness different from that of other surfaces of the main body such that the first surface and the second surface have higher thermal conductivity than the other surfaces.

According to the above aspect (10), the first surface and the second surface with which the heat transfer member comes into contact are adjusted to have roughness different from that of the other surfaces of the main body, and thus it is possible to improve the thermal conductivity of the first surface and the second surface. This can reduce the thermal resistance between the heat transfer member and the first surface and between the heat transfer member and the second surface and effectively alleviate the temperature distribution of the housing structure.

(11) In another aspect, in any one of the above aspects (1) to (10), the heat transfer member includes a material having a linear expansion coefficient larger than that of the main body.

According to the above aspect (11), for example, when the temperature rises during operation of the rotary machine, the heat transfer member expands more than the main body. Accordingly, it is possible to favorably apply the compressive load from the main body to the heat transfer member sandwiched between the first surface and the second surface.

(12) In another aspect, in any one of the above aspects (1) to (11), the heat transfer member is a heat transfer sheet formed by laminating graphene sheets.

According to the above aspect (12), the heat transfer sheet including graphene having favorable heat transfer characteristics is employed as the heat transfer member, and thus it is possible to effectively alleviate the temperature distribution that may occur in the housing structure.

(13) In another aspect, in any one of the above aspects (1) to (11), the heat transfer member includes a composite material of a metal and a crystalline carbon material.

According to the above aspect (13), by configuring the heat transfer member as a composite material of a metal (e.g., any one or more of copper, aluminum, iron, nickel, or the like) and a crystalline carbon material (e.g., any one or more of graphite, fullerene, carbon nanotubes, diamond, or the like), a heat transfer member that is easy to be formed and has excellent thermal conductivity is obtained.

(14) In another aspect, in any one of the above aspects (1) to (13), the housing structure is a turbine casing configured to accommodate a turbine rotor blade (e.g., the turbine rotor blade 10 of the above embodiments) as the rotating body.

According to the above aspect (14), it is possible to effectively alleviate the temperature distribution that may occur in the turbine casing accommodating the turbine rotor blade as the rotating body. Accordingly, it is possible to effectively avoid a situation in which the turbine rotor blade comes into contact with the inner surface of the turbine casing due to a decrease in clearance caused by the temperature distribution.

(15) A method of manufacturing a housing structure for a rotary machine according to an aspect is a method of manufacturing a housing structure for a rotary machine, the housing structure enclosing a rotating body at least partially, the method including: processing a main body such that a first surface and a second surface are formed to face each other; and inserting a heat transfer member into a gap formed between the first surface and the second surface, the heat transfer member having a thickness set such that the gap becomes zero during operation of the rotary machine.

According to the above aspect (15), the heat transfer member is inserted into the gap formed between the first surface and the second surface by processing the main body. The thickness of the heat transfer member is set such that a gap formed between the first surface and the second surface becomes zero during operation of the rotary machine. Accordingly, the heat transfer member can be inserted into the gap while receiving a compressive load from the main body side.

(16) In another aspect, in the above aspect (15), in the processing of the main body, an outer segment and an inner segment between which a gap is capable of being formed are prepared, the gap allowing the heat transfer member to be inserted therein, and in the inserting of the heat transfer member, the heat transfer member is compressed by sandwiching the outer segment and the inner segment in a state in which the heat transfer member is inserted between the outer segment and the inner segment.

According to the above aspect (16), the outer segment and the inner segment are sandwiched and assembled in a state in which the heat transfer member is inserted between the outer segment and the inner segment, and thus it is possible to favorably apply a compressive load to the heat transfer member.

(17) In another aspect, in the above aspect (15), in the processing of the main body, the gap formed in the main body has a slit shape, and in the inserting of the heat transfer member, the heat transfer member is inserted into the gap by heating the main body or cooling the heat transfer member.

According to the above aspect (17), the heat transfer member is inserted into the gap formed into a slit shape in the main body by heating the main body or cooling the heat transfer member, and thus it is possible to favorably apply a compressive load to the heat transfer member.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A housing structure for a rotary machine, the housing structure enclosing a rotating body at least partially and comprising:
a main body including a first surface and a second surface facing each other; and
a heat transfer member including a material having higher thermal conductivity than that of the main body, the heat transfer member being sandwiched between the first surface and the second surface while receiving a compressive load from the first surface and the second surface.

2. The housing structure for the rotary machine according to claim 1, wherein
the heat transfer member extends along a circumferential direction of the rotary machine.

3. The housing structure for the rotary machine according to claim 1, wherein
the first surface and the second surface are inner surfaces of the main body divided in a radial direction of the rotary machine.

4. The housing structure for the rotary machine according to claim 1, wherein
the main body includes:
a curved portion configured to partially surround the rotating body; and
a flange portion provided at an end of the curved portion, and
the heat transfer member is provided from the curved portion to the flange portion.

5. The housing structure for the rotary machine according to claim 1, wherein
the heat transfer member extends along a radial direction of the rotary machine.

6. The housing structure for the rotary machine according to claim 1, wherein
the first surface and the second surface are inner surfaces of a slit-like gap formed in the main body.

7. The housing structure for the rotary machine according to claim 1, wherein
the heat transfer member extends along an axial direction of the rotary machine, or a plurality of the heat transfer members are arranged along the axial direction of the rotary machine.

8. The housing structure for the rotary machine according to claim 1, wherein
the main body includes a communication hole configured to communicate the heat transfer member with an outside space or an inside space of the main body.

9. The housing structure for the rotary machine according to claim 1, wherein
the heat transfer member is in direct contact with the first surface and the second surface.

10. The housing structure for the rotary machine according to claim 1, wherein
the first surface and the second surface are adjusted to have roughness different from that of other surfaces of the main body such that the first surface and the second surface have higher thermal conductivity than the other surfaces.

11. The housing structure for the rotary machine according to claim 1, wherein
the heat transfer member includes a material having a linear expansion coefficient larger than that of the main body.

12. The housing structure for the rotary machine according to claim 1, wherein
the heat transfer member is a heat transfer sheet formed by laminating graphene sheets.

13. The housing structure for the rotary machine according to claim 1, wherein
the heat transfer member includes a composite material of a metal and a crystalline carbon material.

14. The housing structure for the rotary machine according to claim 1, wherein
the housing structure is a turbine casing configured to accommodate a turbine rotor blade as the rotating body.

15. A method of manufacturing a housing structure for a rotary machine, the housing structure enclosing a rotating body at least partially, the method comprising:
processing a main body such that a first surface and a second surface are formed to face each other; and
inserting a heat transfer member into a gap formed between the first surface and the second surface, the heat transfer member having a thickness set such that the gap becomes zero during operation of the rotary machine.

16. The method of manufacturing the housing structure for the rotary machine according to claim 15, wherein
in the processing of the main body, an outer segment and an inner segment between which the gap is capable of being formed are prepared, the gap allowing the heat transfer member to be inserted therein, and
in the inserting of the heat transfer member, the heat transfer member is compressed by sandwiching the outer segment and the inner segment in a state in which the heat transfer member is inserted between the outer segment and the inner segment.

17. The method of manufacturing the housing structure for the rotary machine according to claim 15, wherein
in the processing of the main body, the gap formed in the main body has a slit shape, and
in the inserting of the heat transfer member, the heat transfer member is inserted into the gap by heating the main body or cooling the heat transfer member.
